(19) United States
(12) Patent Application Publication
(10) Pub. No.: US 2012/0148778 A1
(43) Pub. Date: Jun. 14, 2012

(54) Mat apparatus preventing the spread of bacteria infection

(76) Inventor: Jacqueline Anne Dawkins, Chicago, IL (US)

(21) Appl. No.: 13/374,111

(22) Filed: Dec. 12, 2011

Related U.S. Application Data
(60) Provisional application No. 61/422,044, filed on Dec. 10, 2010.

(51) Int. Cl. B32B 3/26; B32B 7/10; B32B 3/10; B32B 3/00; C09J 7/04; B32B 5/22; B32B 33/00

(52) U.S. Cl. 428/40.1; 428/195.1; 428/141; 428/43

(57) ABSTRACT

A mat apparatus for preventing the transmittal and/or transference of contact-based bacteria is disclosed. A first layer of the mat is composed of a cloth-like textile, the first layer having a plurality of pores for absorbing moisture when in contact with a bodily surface. A second layer is composed of a water-resistant material adhered to an opposing side of the first layer for providing a barrier between the first layer and a floor, wherein at least another portion of the second layer extending beyond the first layer is bent to avoid contacting the floor.

### CROSS-REFERENCE TO RELATED APPLICATION

This application claims the benefit of U.S. Provisional Application No. 61/422,044, filed Dec. 10, 2010.

### BACKGROUND

Gymnasiums, locker rooms, pools and other shared facilities are often places where bacteria is commonly bred and transmitted. Consequently, infections such as Athlete's Foot and other forms of fungal and bacterial infection are commonplace among patrons who frequent these facilities. To avoid this hazard, many people resort to placing a towel or article of clothing on the floor that they can step on to prevent direct contact with the floor. Unfortunately, this results in contamination of the towel or article of clothing used. Furthermore, while providing some barrier between the feet and the floor, towels and clothing are porous. Consequently, the bacteria or fungus the user was attempting to thwart can be readily absorbed into the material and transferred to the person's feet.

### BRIEF DESCRIPTION OF THE DRAWINGS

The embodiments of the invention are illustrated by way of example, and not by way of limitation, in the figures of the accompanying drawings:

FIGS. 1A and 1B are diagrams of a top view of a mat apparatus, according to various embodiments;

FIG. 1C is a diagram of a bottom view of the mat apparatus, according to one embodiment;

FIGS. 2A and 2B are diagrams of a side view of a mat apparatus for preventing the transmittal and/or transference of contact-based bacteria, according to various embodiments;

FIGS. 3A-3C are diagrams of a mat apparatus in use by a person for preventing surface contact, according to various embodiments;

FIG. 4 is a diagram of the mat apparatus of FIG. 1 in sectional form, according to one embodiment;

### DESCRIPTION OF SOME EMBODIMENTS

Examples of a mat apparatus as well as exemplary usage thereof said apparatus is disclosed. In the following description, for the purposes of explanation, numerous specific details are set forth in order to provide a thorough understanding of the embodiments of the invention. Although the various exemplary embodiments are described with respect to a mat for use on a floor, it is contemplated these embodiments may be used in any setting where the prevention of bodily contact with a surface is required. This may include, for example, hospitals and other medical facilities, airports, bathrooms and any other environments where bacteria, fungi and other contact-based bacteria may persist and be transmitted and/or transferred from person-to-person.

Also in certain embodiments, the mat is shown to accommodate placement of a single foot at a time while in other embodiments, the mat accommodates both feet at a time. The exemplary embodiments herein are not limited to any one implementation, orientation, aesthetic criteria, etc. Rather, the mat as described herein may be implemented in various shapes, sizes and arrangements for accommodating the placement of one or more feet. It is apparent to one skilled in the art that the embodiments of the invention may be practiced without the specific details provided herein or with an equivalent arrangement.

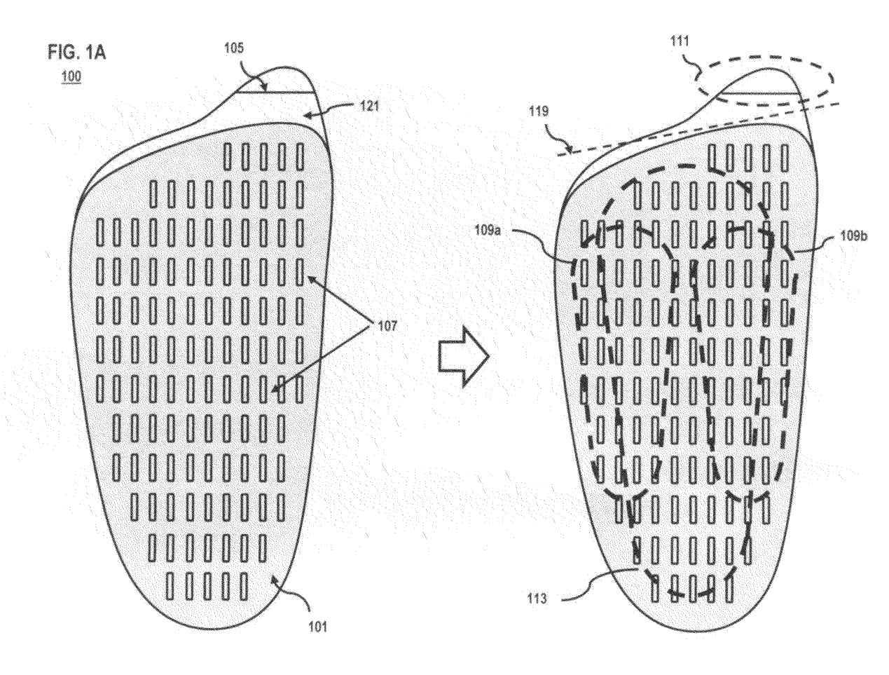

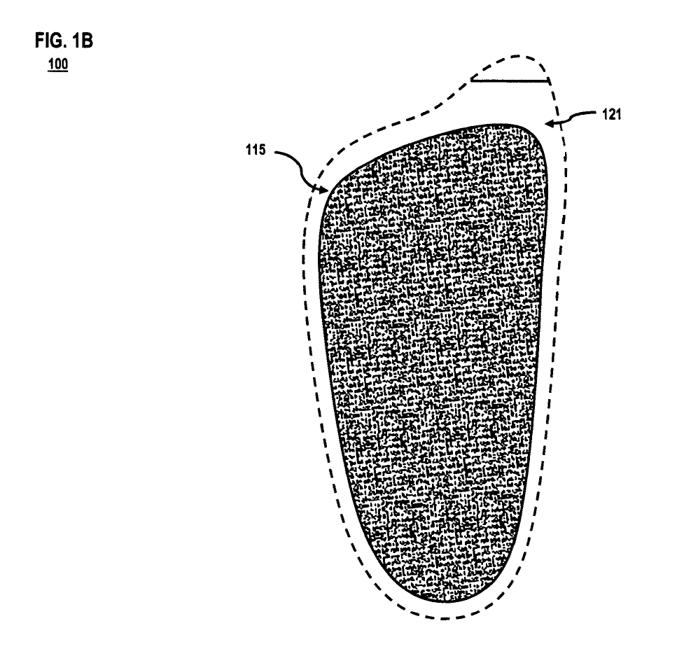

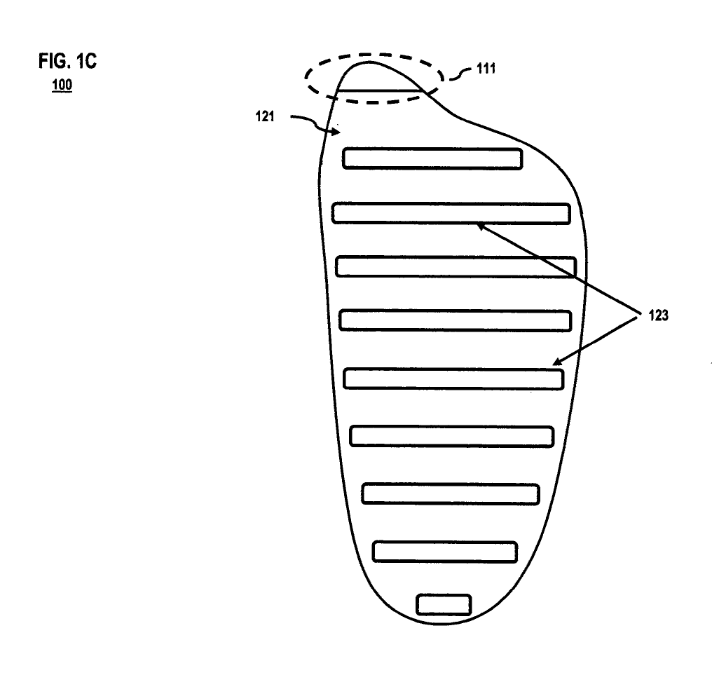

FIGS. 1A and 1B are diagrams of a top view of a mat apparatus, according to various embodiments. By way of example, the mat apparatus is implemented in such a manner as to prevent the passage and transference of contact-based bacteria. Contact-based bacteria may include, for example, any form of bacteria, fungi or other infections that are passed on to a person as a result of bodily contact. This bacteria may reside upon or be absorbed by the skin when the body makes contact with a surface exposed to said bacteria. This includes, for example, Athletes Foot and other fungal infections. In certain embodiments, the mat apparatus is composed of a multi-layered, paper-based material for enabling easy transport and disposal of the mat by a user. In addition, the mat apparatus 100 features a distinguishable flap, corresponding to at least a portion of one of the layers, for supporting rapid removal and application of the mat to a surface requiring cover (e.g., a floor).

Shared facilities such as locker rooms and bathroom areas are breeding grounds for contact-based bacteria and infections such as Athlete's Foot. For example, in most locker rooms, it is commonplace for people to walk around barefoot and thus, constantly make contact with the floor as they go about the task of showering or dressing themselves, etc. To avoid excessive contact with the floor, many people resort to placing a towel or article of clothing on the floor that act as a barrier between their feet and the floor. However, while this may be convenient, this results in the contamination of the towel or article of clothing used as well as unnecessary wrinkling of the article of clothing. Furthermore, while providing some layer of prevention, towels and clothing are typically porous and bacteria or fungus can be readily absorbed through the porous material; providing another means of transmission and/or transference.

To address this issue, the mat apparatus 100 features a top layer 101, composed of a cloth-like textile for making contact with the feet (or a foot) of a user of the mat. The top layer 101 provides the user with comfort and treatment. In addition, the mat apparatus 100 features a bottom layer 121, as shown in FIG. 1D that is composed of a water-resistant material for making contact with a surface (e.g., the floor). The bottom layer 121 provides the user with protection and prevention from contact with at risk surfaces. Still further, the mat 100 may include a third layer in the form of an absorbent pad 115, as shown in FIG. 1C, for absorbing and retaining any moisture that penetrates the top layer 101. This layer provides the user with additional comfort and moisture retention.

As will be discussed more fully, the top and bottom layers 101 and 121 respectively are affixed adjacently to one another, in a co-planar arrangement, for providing a barrier between the feet of the user and the floor. In certain embodiments, the top and bottom layers 101 and 121 respectively form at least a portion of the body of the mat and are affixed by way of an adhesive, a stitching technique, chemical integration means, or the like.

The cloth-like textile of which the top layer 101 is composed may include, for example, any woven or non-woven fabric that is soft, durable and has absorbent qualities. This may include materials made from plastic resins, such as nylon, polyester, polyethylene, or polypropylene. Alternatively, the top layer 101 may be composed of fibrous paper or other materials for formulating a porous, interlocking network of fiber loops. Still further, it is contemplated in certain embodiments that the top layer 101 is composed of a combination of the above described materials, and fabricated in the form of a sheet of continuous fabric for formulating a layer. Any combination of methods for providing a level of comfort and absorbency to a user when they make bodily contact with the mat 100 is applicable.

As a sheet of continuous fabric/material, the top layer 101 includes a top plane and bottom plane wherein the top plane makes contact with a foot of the user and the bottom plane makes contact with the absorbent pad 115, the bottom layer 121, or a combination thereof. By way of example, the bottom plane of the top layer 101 is laid upon and/or attached to a top plane of the bottom layer 121. The top plane of the bottom layer 121 is shown in FIG. 1A while the bottom plane of the bottom layer 121 is shown in FIG. 1C. By way of this configuration, a user viewing the mat 100 from a top surface perspective is able to recognize the following: (1) the top layer 101 is substantially oriented atop the bottom layer 121 such that at least a portion of the perimeter of the top layer 101 is equivalent to a portion of the perimeter of the bottom layer; and (2) the surface area comprised by the bottom layer 121 relative to the floor is greater than the surface area comprised by the top layer 101.

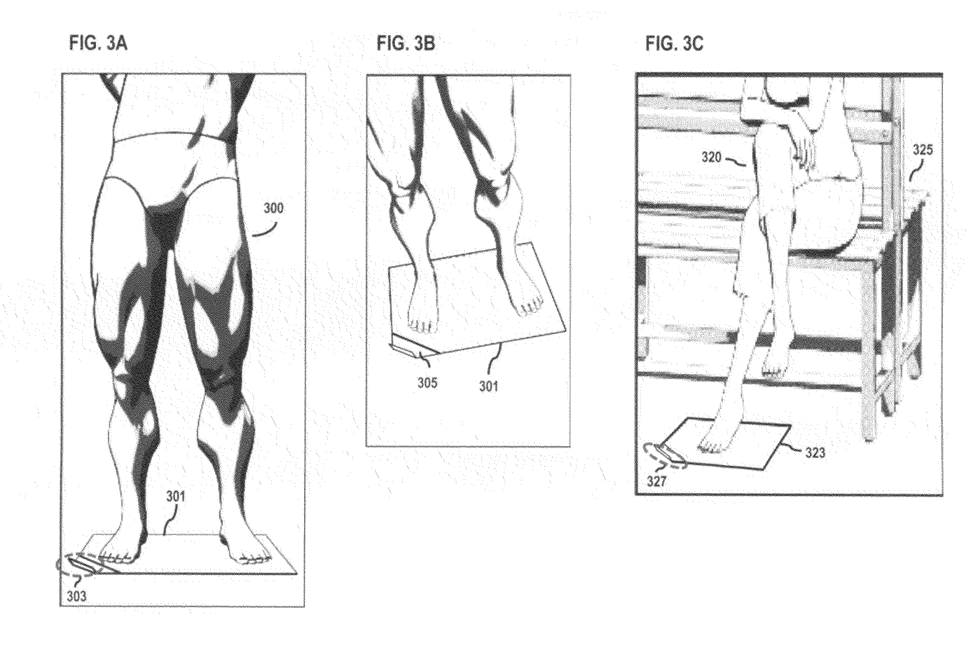

As such, the top layer 101 is encompassed in its entirety by the bottom layer 121, while at least a portion of the bottom layer 121 can be seen to extend beyond the perimeter of the top layer 101. For the exemplary design (e.g., shape and curvature) of the mat 100 as presented in FIGS. 1A-1C, this portion of the bottom layer 121 corresponds to the upper portion of the bottom layer 121, also referred to herein as the flap portion or flap. For the purpose of illustration, the flap corresponds to the portion of the mat 100 corresponding to the bottom layer 121 for enabling easy removal of the mat from the floor. As will be noted throughout, the ability of the user to distinguish between the top and bottom layers 101 and 121 respectively, such as by identifying the flap, recognizing surface area differences, etc., increases the overall ease of use, application and disposal of the mat 100. This is of particular importance in instances where the top and bottom layers 101 and 121 respectively are composed of material within the same family (e.g., paper-based). Also, as will be noted more fully with respect to FIGS. 3A-3C, the mat may be implemented in various shapes, sizes and arrangements accordingly.

In certain embodiments, the flap or upper portion of the bottom layer 121 features a fold line 105 for extending about a portion of the flap; such that a portion of the flap folds. This fold portion 111 enables the corresponding section of the flap to bend and/or protrude upwards, away from the floor. In addition, the fold portion 111, the flap, or a combination thereof have no adhesive backing, anti-slip agents or other adherents added thereto for reducing slippage or affixing the mat 100 to the floor. As such, a user standing upon the mat with their feet at positions 109a and 109b, can readily pluck and lift the bottom layer 121 off the floor without having to touch the floor. This is in direct contrast to flat lying mats or towels, where the user must touch the underside of the mat or pickup the soiled towel and risk making bodily contact with the floor or any absorbed bacteria.

By way of example, in FIG. 1 the fold line 105 is shown to extend about a portion of the width of the bottom layer 121 for creating the fold portion 111 of the flap. In certain embodiments, the fold portion 111 is made of the same material as the entirety of the bottom layer 121. Alternatively, the fold portion 111 is composed of cardboard, corrugated paper, or the like for enabling it to naturally protrude or bend upwards an extent from the floor when the mat is applied. The extent of the bend or protrusion of the fold portion 111 may vary depending on the materials used, the amount of folding of the portion 111 prior to removal of the mat from any packaging, etc. As noted previously, this fold portion 111 also provides another distinction between the top layer 101 and bottom layer 121 for promoting ease of use and removal.

The fold line 105 may be placed in various different positions along the flap. For example, the line can be positioned to extend from opposing edges of the bottom layer for creating a corner based fold portion 111. As another example, the fold line 105 can be oriented substantially close to a perimeter edge of the top layer 101 for enabling folding of a greater portion of the flap (e.g., as per line 119).

In certain embodiments, the top layer 101 also includes a plurality of pores 107 or channels for attracting and absorbing moisture residing on a user's foot as it contacts the mat. For example, when the person places their foot in a position 113 against the top layer 101, the pores trap any water deposits on the foot due to their wide and varied distribution throughout the top layer 101. The pores 107 may be imprinted, embossed or otherwise embedded into the top layer 101 in a similar manner as a paper-towel or other material. The combination of the pores 107 and gaps between the towel's fibers can hold moisture due to surface tension, while capillary action helps bond the moisture together. As shown, the pores 107 may be arranged in various patterns of shapes, i.e., circles, diamonds or ovals, and placed substantially about the entire surface of the top layer 101. The pattern of the material and microscopic spaces within the pattern of pores 107 increases the ability of the top-layer 101 to absorb and hold moisture. It is noted that the sheet of cloth-like material comprising the top layer 101 may also be treated with a sizing agent or resin for affecting the overall wet strength and durability of the mat 100.

In FIG. 1B, the absorbent pad 115 is shown as it lies atop the bottom layer 121. As such, one side of the absorbent pad 115 makes contact with a top plane of the bottom layer 121 while another makes contact with a bottom plane of the top layer 101. The absorbent pad 115 absorbs and retains body moisture—i.e., to prevent excessive dampening while maintaining a level of comfort for a foot 113 or feet 109a and 109b contacting the top layer 101. In certain embodiments, the absorbent pad 115 may be composed of a mixture of polymer and fibrous materials for maximizing absorbency. For example, the polymer may be made of fine particles of an acrylic acid derivative, such as sodium acrylate, potassium acrylate, or an alkyl acrylate. In addition, the absorbent pad 115 may be designed with a polymer featuring gelatinous compounds that react to water, such as hydrogels, superabsorbents or hydrocolloids. Any means of production of the pad 115 for supporting comfort while maximizing absorption and moisture retention is acceptable.

Alternatively, the mat 100 may be produced without the absorbent pad 115. Under this scenario, the top layer 101 and bottom layer 121 make more contact with one another and absorbency is a function of the top layer 101 only.

In FIG. 1C, a perspective of the bottom plane of the bottom layer 121 is shown. Unlike the top layer 101, the bottom layer 121 makes direct contact with the floor, with the exception of the folding portion 111. Also, the bottom layer 121 is composed of a water-resistant material, such that water is prevented to a substantial extent from permeating or traveling through the bottom layer 121. By way of this approach, the bottom layer 121 provides the user of the mat 100 with a barrier for preventing: (1) the foot from contacting the floor; (2) transference of bacteria upward from the floor to the foot due to absorption; and (3) transmission/transmittal of bacteria downward from an infected foot to the floor.

In certain embodiments, the bottom layer 121 is composed of paper that has been treated with a sizing agent (e.g., surface sizing and/or internal sizing). Alternatively, the bottom layer 121 is composed of a polymer-based substrate or a densely packed, flexible material such as wax paper. It is contemplated in certain embodiments that the bottom layer 121 is composed of a combination of the above described materials, and fabricated in the form of a sheet of continuous fabric for formulating a layer. Thus, any combination of methods for providing a level of prevention and water-resistance or repellence to a user when they make bodily contact with the mat 100 is applicable.

In certain embodiments, the bottom layer 121 includes on at least the bottom plane one or more adhesive elements, non-skid elements, or other implements 123 for adherence of the bottom layer 121 of the mat 101 to a surface. By way of example, the adhesive elements 123 may be strips of reusable, pressure-sensitive adhesive for enabling the user to press the mat 101 into place against the floor during first use. Alternatively, course or granular particles such as sand of various types may be embedded into or added to the paper for producing an anti-skid effect. Regardless of approach, as noted previously, the portion of the bottom layer 121 corresponding to the flap or at least the fold section 111 is without adhesive or non-skid elements of any type. As such, a user of the mat 100 can quickly remove the mat 100 from the floor as well as quickly distinguish between the first and second layers 101 and 121 respectively.

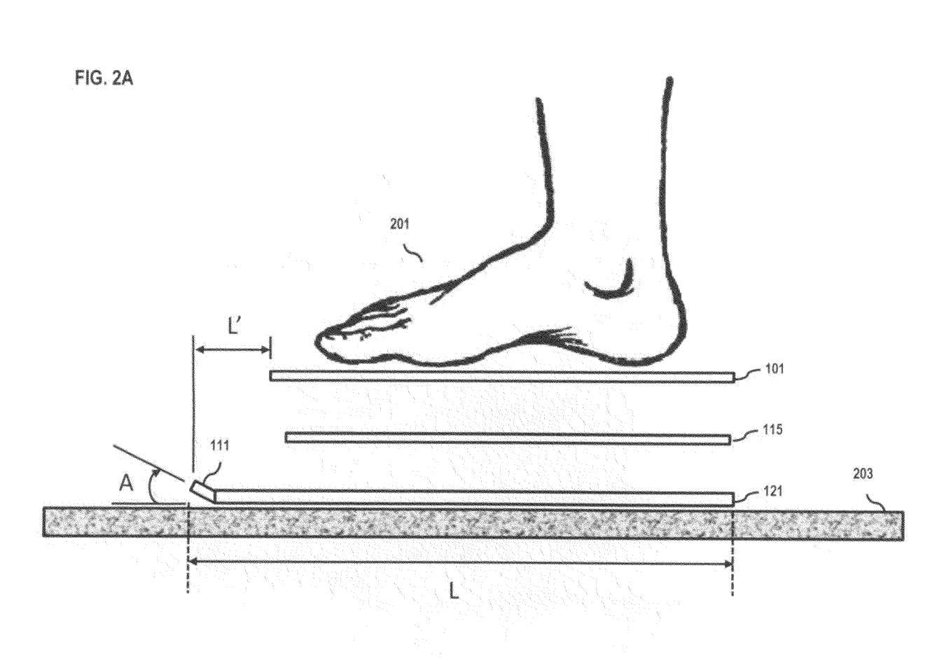

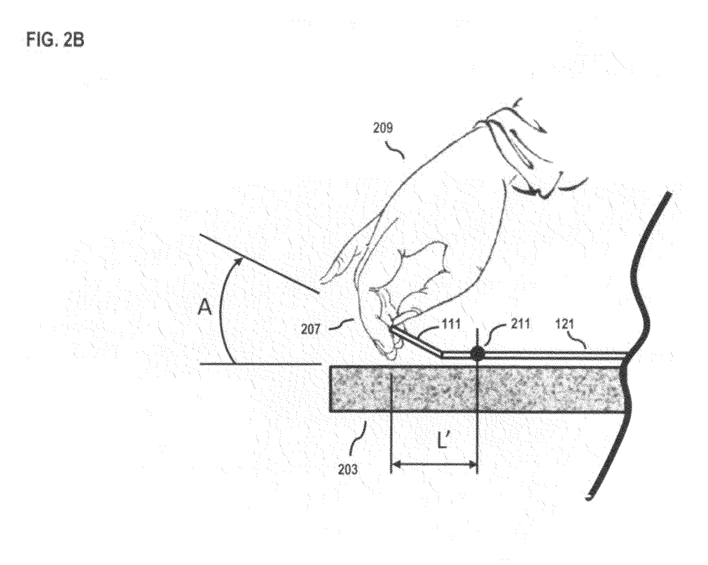

FIGS. 2A and 2B are diagrams of a side view of a mat apparatus for preventing the transmittal and/or transference of contact-based bacteria, according to various embodiments. By way of example, a side perspective of the different layers of the mat, including the first, second and third layers (absorbent pad) 101, 121 and 115 respectively are shown in non-integrated/separated form. As noted, the top layer 101 is oriented to make contact with the bottom of the foot 201 of a user, while the second layer 121 is oriented to make contact with the floor, a bench, the ground, or any other surface. Also, the third layer or absorbent pad 115 is oriented between the first layer 101 and second layer 121.

In certain embodiments, the different layers vary in length relative to one another. For example, in the exemplary design depicted in FIGS. 1A-1C, the length L of the bottom layer exceeds the length of layers 115 and 101. This corresponds to the greater surface area of the bottom layer 121 relative to the floor 203 that the other layers 115 and 101 (assuming they all share the same width characteristics). As a result of this greater surface area, a portion of the second layer 121 of length L′ extends beyond the perimeter of the top layer 101 for permitting the user to view a natural separation between the part 101 of the mat they step on and the part 121 adhered to the floor.

Also, the bottom layer 121 includes a flap that features a flap portion 111. By way of example, the flap portion 111 is shown to be bent upwards in a direction away from the plane of the floor. The bend corresponds to an angle of protrusion of extent A. Any extent of protrusion of at least a portion of the bottom layer 121 from the floor 203 is sufficient for enabling the user to pull up the mat. Lack of adherence of the elements to this portion of the bottom layer 121 also expedites the removal process. The removal process is depicted in FIG. 2B, which shows a cross-sectional, expanded view of the mat as it is being removed by a user.

When a user is ready to remove the mat from the floor, ground, etc., 203 for subsequent disposal, the user places one or more of their fingers underneath the fold portion 111 of the flap. Clearance is provided by virtue of the angle of protrusion A of the fold portion 111 from the surface 203, which in this case enables the user to apply multiple fingers 207 to the removal task. The user then proceeds to pull the flap portion away from the floor, such that the adhesive bonds between the bottom layer 121 and the surface 203 are broken.

Of note, both the flap and associated fold portion of the bottom layer 121 may be configured to not have any adhesive elements applied to them. The removal process is therefore facilitated in a controlled manner such that the risk of contact with the floor by the hand during the removal phase or of touching the bottom plane of the bottom layer 121 during the removal phase is minimized. For example, because the flap may extend beyond the first layer 101 a length L′, pulling up of the flap portion 111 results in additional clearance of the users hand 209 from the floor as the flap portion begins to lift as well. By the time the bottom layer 121 is pulled to a point 211 corresponding to the point of separation between the first layer 101 and the second layer 121, the user has enough clearance to disengage the other portion of the second layer 121 having adhesives thereon with ease.

It is noted, with respect to FIG. 2A, that layers 101, 121 and 115 may be of equivalent or different thicknesses depending on implementation requirements. It is also contemplated that the mat may be provided to the user, in an integrated/connected form, via an individual package and made available in different grades. Hence, in this scenario, the thickness of the layers 101, 115 and 121 may correspond to a particular grade variation of a given mat. For instance, a first grade may correspond to a first overall level of prevention/comfort of the mat, a second grade to a second level of prevention/comfort of the mat, etc. The grades and hence corresponding thickness of the layers and/or overall mat may be suited for different environmental settings, such as a locker room setting (standard grade) versus an industrial setting (high grade).

FIGS. 3A-3C are diagrams of a mat apparatus in use by a person for preventing surface contact, according to various embodiments. For the purpose of illustration, the figures are described from the perspective of a user case of a person at in a locker room setting. Also, for the purpose of illustration, the mat is shown in accordance with a different shape and/or size than previously discussed. As stated before, the aesthetic qualities, including the size, color, shape and general orientation and means of overlap of the different layers may vary. The exemplary embodiments and novel features of the invention as described nonetheless still apply.

In FIGS. 3A and 3B, a user 300 is in the locker room and decides to deploy a mat 301. After removing the mat 301 from its air sealed package and unfolding it, the user 300 applies the bottom plane of the bottom layer 121 to the floor of the locker room. The application may include adherence of the bottom layer to the floor via one or more adhesives. The user 300 is able to configure the mat in front of their locker for optimal use—i.e., such that the fold portion 303 is facing up, away from the floor. In addition, the flap 305 of the bottom layer is easily recognized as well as the various pores of the top layer for indicating where the user may comfortably step. In the case of the user 300 being tired from a long workout, they may apply the adhesive and/or non-skid backing (corresponding to the bottom plane of the second layer 121) to the floor with foot-applied pressure, thus avoiding bending down.

As the user's 300 feet are slightly wet after having come from the shower, the mat absorbs and traps the moisture. The absorbent pad retains excess moisture via its network/matrix of interlocked chambers, while at the same time preventing release of the water back onto the top layer. Consequently, the user 300 is able to get dressed comfortably. Once they are finished, the user pulls the bottom layer up by way of the fold portion 303 and disposes of the mat.

In FIG. 3C, a user 320 applies a mat 323 to the floor as they are seated at a bench 325 and proceeds to get dressed. Once the user 320 puts on their shoes, they bend down towards the fold portion 327 and lift the mat up 323. As water on the user's foot is absorbed by the mat 323, there is no leakage as the user lift's the mat up from the floor. In this particular case, the user 320 may have applied a mat 323 to the surface of the bench 325 upon which they are seated.

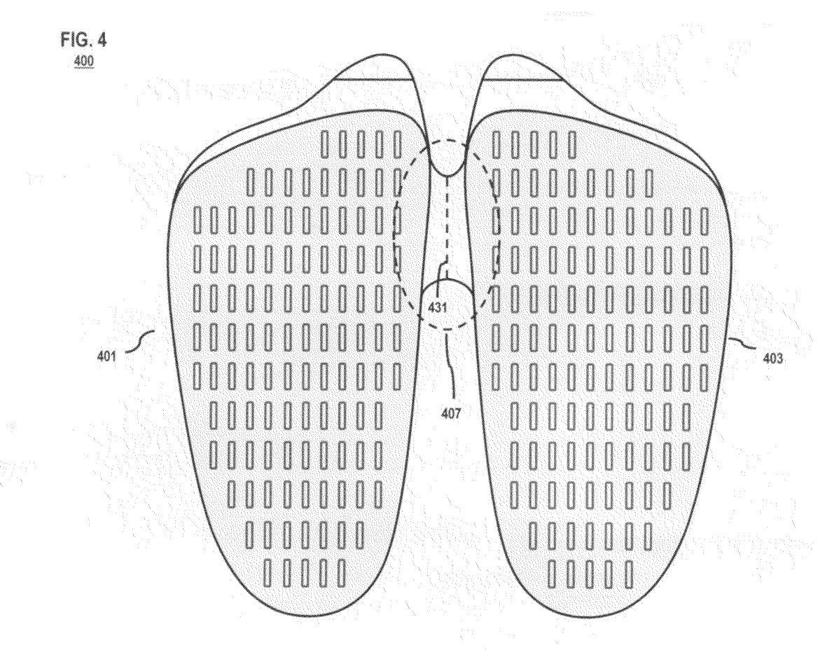

FIG. 4 is a diagram of the mat apparatus of FIG. 1 in sectional form, according to one embodiment. For the purpose of illustration, the mat 400 is similar to that of FIGS. 1A-1C. By way of example, the mat comprises a first portion 401 and a second portion 403 for corresponding to a first (e.g., left) and second (e.g., right) foot respectively. Each of the respective portions 401 and 403 feature a first and second layer along with optional third layer as described with respect to FIGS. 1A-1C. However, the first and second sections 401 and 403 respectively are attached to one another via a common second layer of material that joins them. In this example, the joining occurs at a point of union 407 of the second layer for service respective sections 401 and 403. In certain embodiments, sections 401 and 403 may be disjoined by way of a perforated line 431.

It is noted that this exemplary implementation promotes, for the convenience of the user, separation of a mat 400 into distinct segments 401 and 403 for accommodating different bodily surfaces or user orientations. By way of example, the first and second portions 401 and 403 respectively may be separated and applied to the floor to accommodate a user preference for a wider stance when employing the mat 400 in a standing position. As another example, the first portion 401 may be applied to the floor by the user for accommodating the feet while the second portion 403 is applied to a bench for accommodating the buttocks. Various other implementations may also be contemplated, including other shapes and sizes.

The mat apparatus described herein enables users to prevent the transmittal and/or transference of contact-based bacteria. One advantage of the exemplary embodiments presented herein includes the multi-layered approach afforded by the mat. This includes implementation of a first layer composed of a cloth-like textile, the first layer having a plurality of pores for absorbing moisture when contacting a bodily surface. This layer corresponds to a comfort layer, and may be further translated into a treatment layer. For example, it is contemplated in future embodiments that the first layer may be treated with an anti-bacterial agent, moisturizing agent, or a combination thereof. The anti-bacterial agent may include a sanitization compound, skin cleansing agent, or the like.

As another advantage of the exemplary embodiments presented herein, the mat includes a second layer composed of a water-resistant material adhered to an opposing side of the first layer for providing a barrier between the first layer and a floor. This second layer has a larger surface area than the first layer for encompassing the first layer in its entirety. Also, a portion of the second layer has affixed thereto one or more adhesive elements, non-skid elements, or a combination thereof for adherence of at least the portion of the second layer to the floor. This layer corresponds to a protection layer, and may be further translated into a prevention layer. For example, it is contemplated in future embodiments that the second layer may be treated with an anti-microbial agent. The anti-microbial agent may include an anti-fungal substance, anti-bacterial treatment or any other means of killing contact-based cultures.

As another advantage, at least another portion of the second layer of the mat extends beyond the first layer and is bent to avoid contact with the floor. This bend enables the user to readily remove the mat from the floor with minimal risk of exposure to bacterial infection. In addition, the user is able to readily distinguish between the first and second layers of the mat. It is contemplated in future embodiments that various elements of the first and second layers may feature different colors, different textures, or different indicia. By way of example, the layers may be color coded, such that the flap portion corresponding to the second layer is different in color than the first layer. As another example, the fold portion of the second layer of the mat may feature indicia that reads “PULL HERE” of “LIFT HERE.” Alternatively, the indicia may be provided in the form of a logo or picture.

As yet another advantage, the mat can be individually sealed and/or packaged for convenient transport and deployment by the user. Under this scenario, the mat may feature a removable backing, i.e., composed of a non-stick material for covering the adhesive and/or non-skid elements of the second layer 121. When ready, the user removes the backing to expose the adhesive and/or non-skid elements and ready the mat for application to a surface (e.g., the floor). A separation between an edge of the backing and the fold portion of the second layer can be maintained for allowing a user to pull or peel the backing away from the second layer.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A mat comprising:
a first layer composed of a cloth-like textile, the first layer having a plurality of pores for absorbing moisture when in contact with a bodily surface; and
a second layer composed of a water-resistant material adhered to an opposing side of the first layer for providing a barrier between the first layer and a floor, the second layer having a larger surface area than the first layer for encompassing the first layer in its entirety, a portion of the second layer having affixed thereto one or more adhesive elements, non-skid elements, or a combination thereof for adherence of at least the portion of the second layer to the floor,
wherein at least another portion of the second layer extending beyond the first layer is bent to avoid contact with the floor.

2. A mat of claim 1, wherein the at least another portion of the second layer does not have affixed thereto one or more adhesive elements, non-skid elements, or a combination thereof.

3. A mat of claim 1, wherein the first layer is treated with an anti-bacterial agent, moisturizing agent, or a combination thereof.

4. A mat of claim 1, wherein at least the portion of the second layer having affixed thereto one or more adhesive elements, non-skid elements, or a combination thereof is treated with an anti-microbial agent.

5. A mat of claim 1, wherein the material corresponding to the second layer is treated and the second layer is denser than the first layer.

6. A mat of claim 1, wherein the first layer and second layer are paper based.

7. A mat of claim 1, further comprising:
an absorbent pad for retaining moisture as collected by the first layer.

8. A mat of claim 7, wherein the absorbent pat is placed between the first layer and second layer.

9. A mat of claim 1, wherein the first layer and second layer are different colors.

10. A mat of claim 1, wherein the first layer and second layer are different textures.

11. A mat of claim 1, wherein the first layer and the at least another portion of the second layer have printed thereon different indicia.

12. A mat of claim 1, further comprising:
a backing for encompassing at least the portion of the second layer having affixed thereto one or more adhesive elements, non-skid elements, or a combination thereof for adherence of at least the portion of the second layer to the floor.

13. A mat of claim 12, wherein the backing is peeled away from the second layer.

14. A mat of claim 1, wherein the first layer and second layer are disposable, bio-degradable, or a combination thereof.

15. A mat of claim 1, wherein the first layer, second layer, and absorbent pad are foldable.

16. A mat comprising:
a first and second section corresponding to a first and second bodily surface respectively, each of the first and second sections including,
a first layer composed of a cloth-like textile, the first layer having a plurality of pores for absorbing moisture when in contact with a bodily surface; and
a second layer composed of a water-resistant material adhered to an opposing side of the first layer for providing a barrier between the first layer and a floor, the second layer having a larger surface area than the first layer for encompassing the first layer in its entirety, a portion of the second layer having affixed thereto one or more adhesive elements, non-skid elements, or a combination thereof for adherence of at least the portion of the second layer to the floor,
wherein at least another portion of the second layer extending beyond the first layer is bent to avoid contact with the floor and the first and second sections are attached to one another via the at least another portion of the second layer of material.

17. A mat of claim 16, wherein the at least another portion of the second layer has a perforation between the first and second sections for detaching the first and second sections.

18. A mat of claim 16, further comprising:
an absorbent pad for retaining moisture as collected by the first layer of respective first and second sections, wherein the absorbent pat is placed between the first layer and second layer of the respective first and second sections.

19. A mat of claim 16, further comprising:
a backing for encompassing at least the portion of the second layer having affixed thereto one or more adhesive elements, non-skid elements, or a combination thereof for adherence of at least the portion of the second layer to the floor of respective first and second sections,
wherein the backing is peeled away from the second layer.

20. A mat of claim 16, wherein the first layer of respective first and second sections is treated with an anti-bacterial agent, moisturizing agent, or a combination thereof and at least the portion of the second layer of respective first and second sections having affixed thereto one or more adhesive elements, non-skid elements, or a combination thereof is treated with an anti-microbial agent
